(19) United States
(12) Patent Application Publication
(10) Pub. No.: US 2018/0063041 A1
(43) Pub. Date: Mar. 1, 2018

(54) BUILDING A VIRTUAL GROUP FOR CHATTING GROUPS IN AN INSTANT MESSAGING CLIENT

(71) Applicant: International Business Machines Corporation, Armonk, NY (US)

(72) Inventors: Jonathan Dunne, Dungarvan (IE); Si Bin Fan, Beijing (CN); Chen Jiang, Beijing (CN); Qin Li, Beijing (CN); Yan Rong Shen, Beijing (CN); Chang Ning Song, Beijing (CN); Ping Xiao, Beijing (CN)

(21) Appl. No.: 15/248,209

(22) Filed: Aug. 26, 2016

(51) Int. Cl. H04L 12/58; H04L 29/06

(52) U.S. Cl. CPC H04L 51/04; H04L 65/1066; H04L 65/403

(57) ABSTRACT

Embodiments of the present disclosure build a virtual group in an instant messaging client. A virtual group for a first group related to a first user and at least one second group related to the first user is built. In response to receiving a message and intended recipient of the message from the first user in the virtual group, wherein the receiver candidate are in the first group and/or the at least one second group, the message is sent to the indicated target recipients.

### BACKGROUND

With developments of the communication and computer technologies, a number of advancements have been made to help people to communicate more and more easily. For example, people can communicate via instance messaging tools installed on mobile devices or personal computers, such as WeChat at any time. By using these instant messaging tools, a user can talk with one buddy, or talk with a lot of buddies who form a chat group. Besides, the user can build a chat group as the group administrator, add members to an existing chat group regardless of whether the user is the group administrator or not.

### SUMMARY

In one aspect, a computer-implemented method is disclosed. According to the method, a virtual group for a first group related to a first user and at least one second group related to the first user is built. And in response to receiving a message and receiver candidate of the message from the first user in the virtual group, wherein the receiver candidate is the first group and/or the at least one second group, the message is sent to the receiver candidate.

In another aspect, a computing system is disclosed. The computing system comprises a computer processor coupled to a computer-readable memory unit, the memory unit comprising instructions that when executed by the computer processor implements a method. In the method, a virtual group for a first group related to a first user and at least one second group related to the first user is built. And in response to receiving a message and receiver candidate of the message from the first user in the virtual group, wherein the receiver candidate is the first group and/or the at least one second group, the message is sent to the receiver candidate.

In yet another embodiment, a computer program product is disclosed. The computer program product is tangibly stored on a non-transient machine readable medium and comprising executable instructions which, when executed on an electronic device, cause the electronic device to build a virtual group for a first group related to a first user and at least one second group related to the first user. And in response to receiving a message and receiver candidate of the message from the first user in the virtual group, wherein the receiver candidate is the first group and/or the at least one second group, the message is sent to the receiver candidate.

It is to be understood that the summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 shows an example computer system/server 12 which is applicable to implement embodiments of the present disclosure.

FIG. 2 shows the two chat windows in a first example.

FIG. 3 shows the two chat windows in a second example.

FIG. 4 shows the two chat windows in a third example.

FIG. 5 shows a flow chart of the method for building a virtual group in an instant messaging client according to some embodiments of the present disclosure.

FIG. 6 shows the exemplary interface for the first example on Ann's instant messaging client.

FIG. 7 shows an interface for the first example for building a virtual group for the two groups.

FIG. 8 shows a chat window of the virtual group used in the first example.

Throughout the drawings, same or similar reference numerals represent the same or similar elements.

### DETAILED DESCRIPTION

The present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones describe below.

As used herein, the term “includes” and its variants are to be read as opened terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

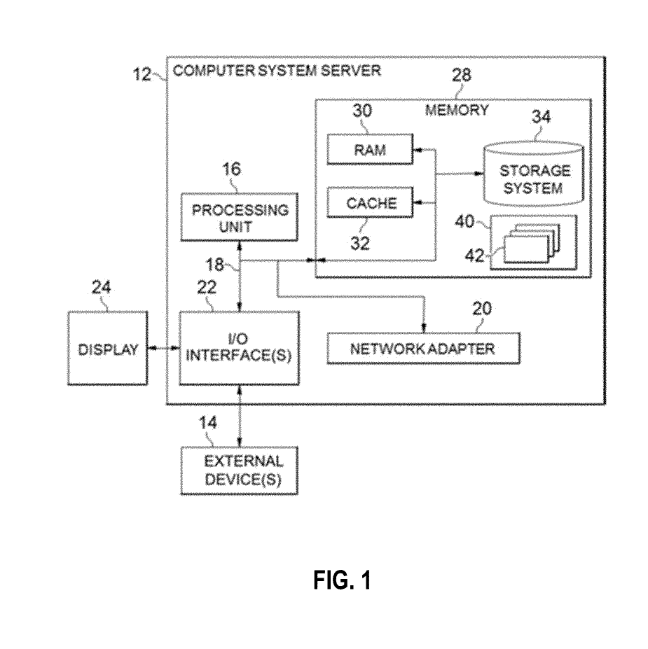

Reference is first made to FIG. 1, in which an example electronic device or computer system/server 12 which is applicable to implement the embodiments of the present disclosure is shown. Computer system/server 12 is only illustrative and is not intended to suggest any limitation as to the scope of use or functionality of embodiments of the disclosure described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, and the like. One or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In some scenarios, a user may want to merge a plurality of groups (a group may consist of one or more members) or sessions into one session so that the user does not need to switch between the groups or sessions frequently. The user may desire to combine these groups because they are sharing, for example, a common theme that the user does not necessarily desire to repeat the same statement across each group individually.

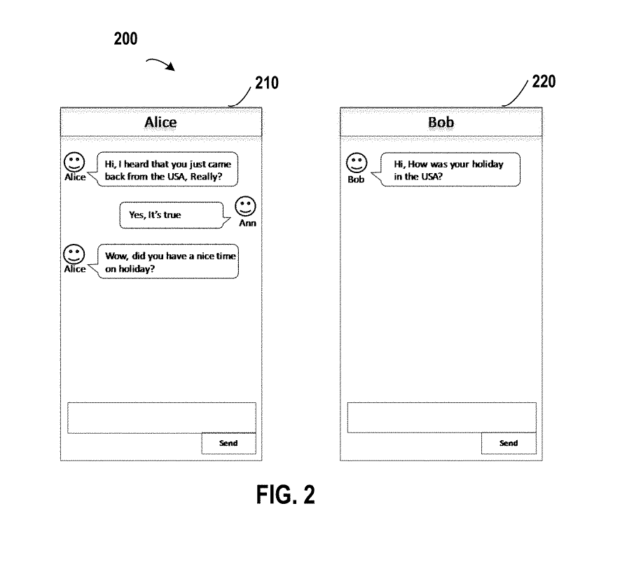

FIG. 2 illustrates 2 chat windows 210 and 220 within an instant messaging client 200. It should be noted that generally the user would not be able to see both chat windows at the same time. However, in other instances the user would be able to view them at the same time. For purposes of this discussion reference will be made to particular individuals and groups. However, the names of the individuals and the groups are provided merely for the convenience of the reader in following the concepts presented herein. Here is a first example, in which Alice and Ann are friends, and Bob and Ann are friends, but Alice and Bob are not friends. Both Alice and Bob are greeting to Ann in different chatting windows (windows 210 and 220 respectively) about Ann's journey in the USA. If Ann merges the two sessions into one physical group, such as adding Bob into the Alice's session, then both Alice and Bob may view all chat contents and also may know each other. However, Alice and/or Bob may be uncomfortable being in the same group, for example, due to a privacy issue. As such Alice or Bob cannot talk as freely as if they were not in the same group. So Ann would not merge them into a physical group. Therefore, she has to switch between the two chat windows and answer the same questions twice.

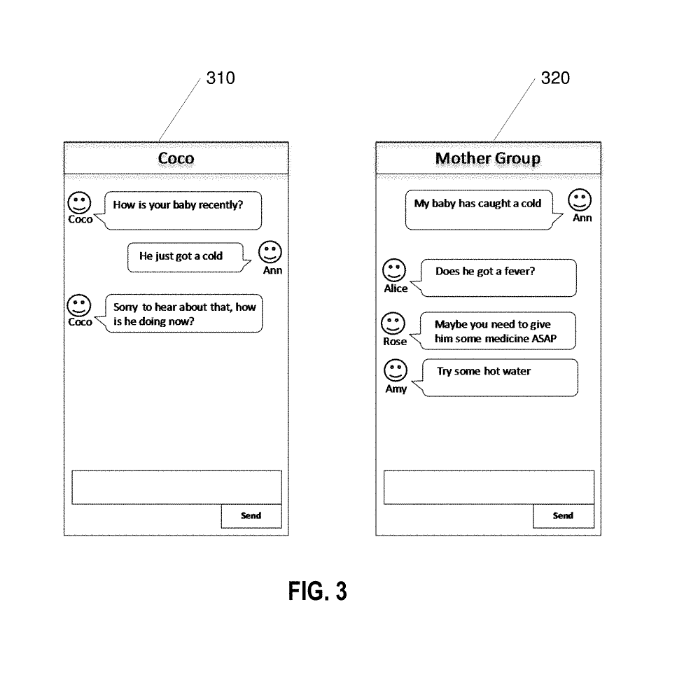

FIG. 3 illustrates a second example of a chat in which Ann is engaged in. In this example Ann is chatting with Coco in window 310 and with a mother's group in window 320. In this example, Coco and Ann are friends, and Ann is in a group named Mother group, but Coco is not in the Mother group. Both Coco and the members in the Mother group are all care about Ann's baby as her baby got a cold recently, and they are giving her advice. If Ann merges the two sessions into one physical group, such as adding Coco into the Mother group, then Coco may view all chat contents in the Mother group. In some scenarios, the Mother group is a specific group whose members work in a same department, while Coco is not a member of the department, it will be not suitable for Ann to add Coco to the Mother group. So Ann again has to switch between the two chat windows and answer the same questions twice.

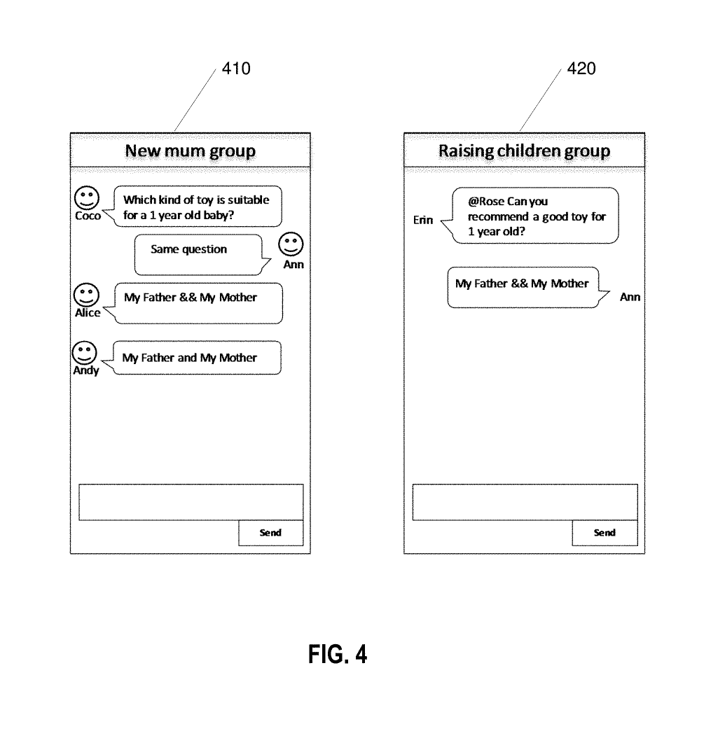

FIG. 4 illustrates a third example, where Ann has joined two different groups which are related to how to raise a child. One is a group named New mum group (window 410) and another is a group named Raising children group (window 420). Both groups often discuss similar topics. Once both groups are active, Ann has to switch frequently between the two chat windows and answer the same questions twice.

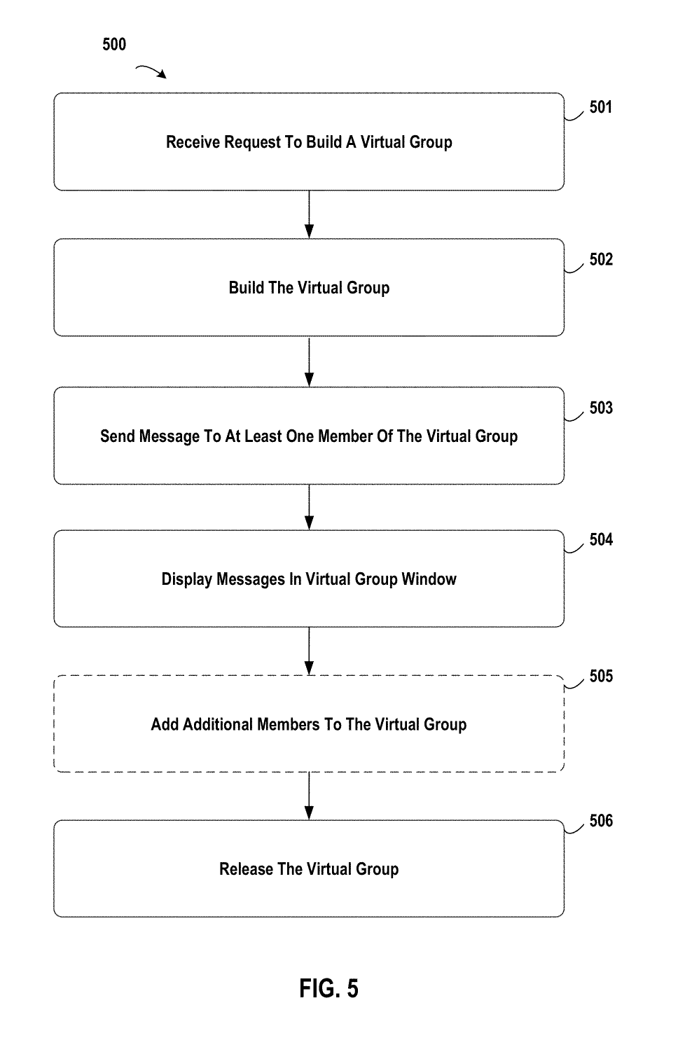

To address the above mentioned issues, present disclosure provides a method for building a virtual group in an instant messaging client. FIG. 5 illustrates a flow chart of the method 500 for building a virtual group in an instant messaging client according to some embodiments of the present disclosure.

The process begins when the instant messaging client receives a request to build a virtual group. This is illustrated at step 501. At this step, the instant messaging client receives a request for building the virtual group for a first group related to a first user and at least one second group related to the first user in the first user's instant messaging client. In some embodiments this step is optional. This may occur as the first user's instant messaging client may be configured to automatically build the virtual group once a particular condition or conditions are satisfied, then the request is not existed in such situation. These conditions can include, for example, the same or similar text entered into two or more of the windows, the same text entered in the windows within a predetermined time period, a particular overlap in members of the group, or any other data points about the chat groups that indicate that they may be related and the user may desire to have a virtual group.

Once the request to build the virtual group is received, the process continues and builds the virtual group. This is illustrated at step 502. At this step, the instant messaging client builds a virtual group for a first group related to a first user and at least one second group related to the first user.

Following the building of the virtual group the process sends a message to the receive candidate. This is illustrated at step 503. At this step in response to receiving a message and receiver candidate of the message from the first user in the virtual group, wherein the receiver candidate is the first group and/or the at least one second group, the instant messaging client sends the message to the receiver candidate.

In the above three examples, Ann's instant messaging client may receive a request for building the virtual group in her instant messaging client since Ann is the first user. In the first example, the first group comprises Ann and Alice, and the second group comprises Ann and Bob. In the second example, the first group comprises Ann and Coco, and the second group comprises members in the mother group. In the third example, the first group comprises members in the New mum group and the second group comprises members in the Raising children group.

In some embodiments, the request is alternatively initiated by the first user's input, e.g. Ann's input. If there are a plurality of chat sessions, Ann may view all existing sessions in one window. The instant messaging client may provide tool for user's input so that the request can be initiated.

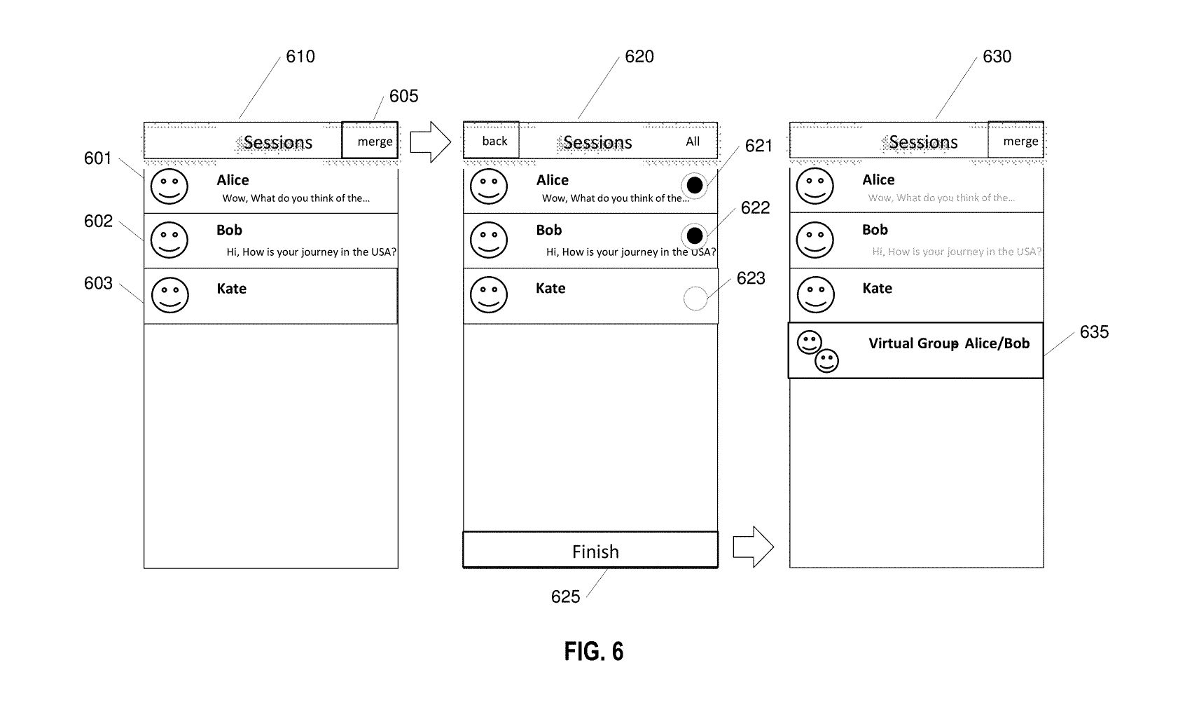

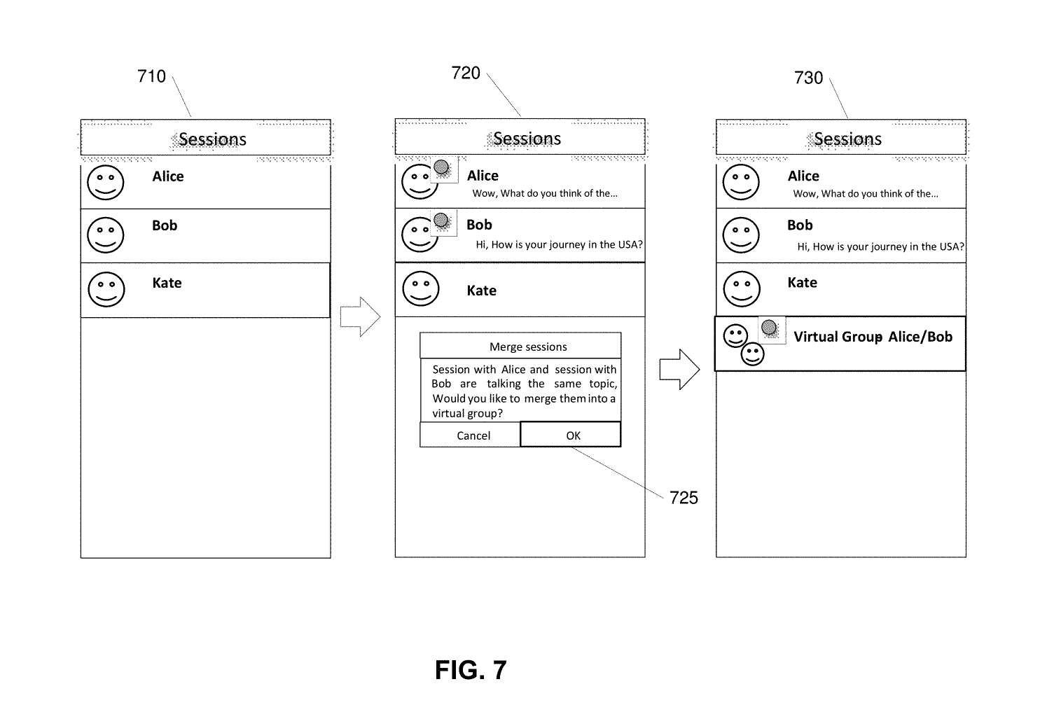

The discussion of the processes at steps 501, 502 and 503 will now be discussed in further detail with reference to FIG. 6 and FIG. 7. FIG. 6 illustrates the exemplary interface for the first example on Ann's instant messaging client, in which Ann may view all existing sessions in her client. The first group is shown as Alice's session 601 and the second group is shown as Bob's session in the interface 602. Also illustrated is a session with Kate 603. The client provides a button 605 for user to input to initiate a merge request. If Ann presses “merge” button 605, then all selectable buttons for all existing sessions will be shown (illustrated by buttons 621, 622 and 623). In this interface, Ann selects both Alice and Bob's sessions, then presses the “finish” button 625. At this time, Ann's instant messaging client receives the request, and then it builds a virtual group, e.g. VirtualGroup-Alice/Bob shown in FIG. 6 as element 635, for the two groups. The virtual group 635 is built by Ann, so the virtual group can be viewed on Ann's client. In this embodiment, only the instant messaging client has been involved while the instant message server has not been involved. The example illustrates how to build a virtual group for two groups, however, it can be understood that Ann's instant messaging client may build a virtual group for more than two groups using the same method. Further, additional groups may be added to the virtual group 635 after the formation of the virtual group.

In some embodiments, the request for building a virtual chat group is initiated by the first user's instant messaging client. In other embodiments the request of building a virtual chat group is initiated by the instant message server. The client or the server save all chat contents in the first group and in the second group, and either of them can compute an intersection quotient between the two groups and then can compare the computed intersection quotient with a first threshold. If the computed intersection quotient satisfies a first threshold, the client or the server may send the request for building a virtual group for the first group and the second group to the client.

FIG. 7 illustrates a series of screens 710, 720, 730 for automatically identifying and building a virtual group. The screen shots illustrate Ann's interface for the first example when Ann's instant messaging client or server initiates a request for building a virtual group for the two groups. In this example the client and/or the server determines on its own, for example, that the two session are discussing the same topic because the computed intersection quotient satisfies with the first threshold. The client and/or server then generates a window in the session that asks the user, “Session with Alice and session with Bob are talking the same topic. Would you like to merge them into a virtual group?” Once the user presses the “OK” button 725 to confirm the request, the client acts as if it received a request for building the virtual chat group for the two sessions, and proceeds to build the virtual group. Alternatively, the client or the server may build a virtual chat group directly without involving user's confirmation. The client or the server decision depends on the user's configuration.

In some embodiments, the intersection quotient between the two groups is related to correlation between current topics talked within the two groups. Alternatively, the intersection quotient between the two groups is related to a correlation between historical topics talked within the two groups. Correlation between topics talked about within the two groups may be computed using text mining technology and Linear Regression techniques which can preprocess text document and extract keywords, However, other technologies and approaches can be used as well. Here all voice message and picture messages can be extracted into text messages using existing technology. In one embodiment all chat records during a defined period are analyzed using text mining technology. Then keywords between two groups are generated and compared with each other to decide whether the two groups are discussing the same topic.

For example, the most recent five input messages, or input messages within 10 minutes, or 1000 text characters in the input messages in each of the two groups are analyzed and their keywords are generated. Here the intersection quotient is defined as the number of the same keywords. Then if the number of the same keywords is greater than a threshold, such as 3, the instant messaging client will initiate the request for building a virtual group for the two groups.

In some embodiments, the intersection quotient between the two groups is related to a correlation between a length of the time the chat has been active for the first group and for the second group. Here the intersection quotient is defined as time difference between latest input times of the two groups. The client or the server computes the time difference and compares it with a threshold. If the time difference is less than the defined threshold, then the client or the server will initiate the request for building a virtual group for the two sessions to the client. For example, if Alice latest input occurred at 10:15 AM today, and Bob latest input occurred at 10:16 AM today, the client or the server computes the time difference as 1 minute and compares it with the threshold, such as 2 minutes, and determines that the time difference is less than the threshold. Then the client or the server may initiate the request to the client for building a virtual group for the two groups.

In some embodiments, the intersection quotient between the two groups is related to the number of common members in the first group and in the second group. Here the intersection quotient is defined as number of common member in the first group and in the second group. The client or the server computes the number of common member and compares it with a threshold number of common members. If the number of common member is greater than the defined threshold, the client or the server will initiate the request for building a virtual group for the two sessions to the client. For example, in the third example (FIG. 4), if the New mum group has 15 members and the Raising children group has 20 members. The client or the server computes and determines that 10 members of each group are the common members. The client and/or server then compares the number of the common members. e.g. 10 with the threshold, such as 8, and finds the number of the common members is greater than the threshold. As a result, it will initiate the request to the client for building a virtual group for the two groups. Here it can be understood that the intersection quotient may also be the percent of common member in the first group and in the second group.

Those skilled in the art may understand that the intersection quotient can also be defined based on any combination of the above embodiments. And the intersection quotient can be defined in other ways.

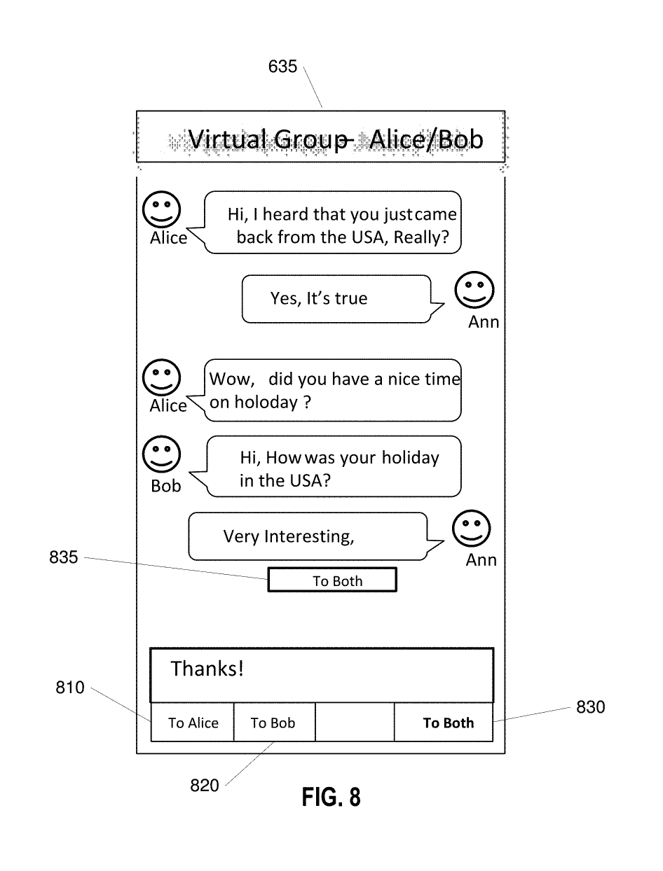

In some embodiments, there is a need for the first user to know the existence of the virtual group, so that the first user is able to chat with the first group and/or the at least one second group in one chat window for the virtual group. FIG. 8 illustrates the chat window of the virtual group 635 used by Ann. According to embodiments of this disclosure, once the virtual group is built, the first user opens the chat window for the virtual group. In some embodiments, Ann's instant messaging client creates a chat window for the virtual group based on any chat window of the first group or the second group. For example, the chat window for the virtual group in FIG. 8 is based on the chat window of Alice's session 602, so the historical chat content of the Alice's session has been preserved in the chat window of the virtual group. In some embodiments, Ann's instant messaging client creates a new chat window for the virtual group which does not include the historical chat content from any of the sessions. Optionally, all historical chat content, whether from Alice's session 602 or from Bob′ session 603, will be shown in the chat window for the virtual group. Alternatively, all historical chat content will not be shown in the chat window for the virtual group. In the chat window of the virtual group, if Ann inputs a message, the instant messaging client will remind Ann which group she will send to, e.g. selection of receiver candidate of the message. Then Ann can select a button to only send to the first group 810, only send to the second group 820, or send to both the first group and the second group 830. Also, once the instant messaging client sends Ann's input message according to Ann's instruction, it also provides reminder 840 below the message in the chat window, such as “To Alice”, “To Bob” or “To both” so that Ann can know who has received the message. However, other indicia can be used to provide Ann with information as to whom the message was sent, such as different colors, fonts, etc.

Referring back to FIG. 5, the messages are displayed from the members of the virtual group. This is illustrated at step 504. At this step the instant messaging client displays messages from members of the virtual group on the virtual group chat window in response to receiving the messages from members of the virtual group. Optionally, the instant messaging client displays messages from members of the virtual group on the chat window of the virtual group even the messages have been received before building of the virtual group so that the first user can view all the communication history among the virtual group in one chat window. In the example of FIG. 8 all the messages from Alice and Bob are shown in the virtual chat window. Their further messages will also be shown on the chat window.

In some embodiments, only the first user in the virtual group is aware of the existence of the virtual group so that the other members can chat freely. So all the virtual group related information will only be reserved in the first user's instant messaging client, and will not be sent to the instant messaging server. Then the other members will not be aware of the existence of the virtual group. Their instant messaging client will be shown as usual; no virtual group related information will be received from the server. For example, in the first example, although there exists a virtual group which, involves Alice and Bob in Ann's instant messaging client, Alice and Bob's clients do not know the virtual group, so both chat with Ann in his/her own chat window respectively, as if the virtual group does not exist.

In some embodiments, the method further allows for the addition of other groups or individuals to the virtual group. This is illustrated at step 505. At this step the instant messaging client adds the at least one third group related to the first user to the virtual group. And optionally, the step 505 further comprises a step of sending a message to a receiver candidate in response to receiving the message and the receiver candidate of the message from the first user in the virtual group, wherein the receiver candidate is the first group and/or the at least one second group an or the at least third group. Using the method, the first user is able to chat with the first group and/or the at least one second group and/or the at least one third group in a single chat window and members except for the first user among the virtual group are not aware of the existence of virtual group.

In one example, the step 505 is performed in response to a request for adding at least one third group to the virtual group. As discussed above, the request is optional since the step can be automatically executed according to the instant messaging client configuration without the request. Still in the first example, the virtual group for Ann, Alice and Bob has been built. Ann is talking freely with his friends in the virtual group. At this time, Ann receives a chat from Andy. Then Ann's instant messaging client may add the group of Andy's session (including Andy and Ann) into the virtual group, in one example, the action is in response to receiving such request. Optionally, the request is initiated by Ann's input. Alternatively, the request is initiated by Ann's instant messaging client or server by analyzing an intersection quotient between the existing virtual group and Andy's session. Same as above, Ann can chat with Alice, Bob or Andy freely, but none of Alice, Bob and Andy is aware of the existence of virtual group, they do not know Ann is talking with three persons in one virtual group, e.g. Alice, Bob or Andy's instant message client is same as usual, they can only view the chat content between herself/himself and Ann.

In some embodiments, the instant messaging client can allow for the closing of an existing virtual group. This is illustrated at step 506. At this step the instant messaging client releases (or closes) the virtual group in response to a request for releasing the virtual group. Once an existing virtual group is released, the virtual group chat window will be closed. And in one embodiment, the chat window of the first group or the second group will also be closed.

The act of releasing an existing virtual group may be initiated by the first user by press a button such as “Release a virtual group” on the existing chat window for the virtual group. Alternatively, the function can be initiated by the instant messaging client or the server, either of them may compute intersection quotients among the groups which have been used to build a virtual group then compare the computed intersection quotients with the second threshold. If the second threshold are satisfied, it will send a request for releasing the existing virtual group to the instant messaging client. Moreover, the instant messaging client may release the existing virtual group directly if a threshold is satisfied. Or the instant messaging client may release the existing virtual group directly if there is no input in predefined time. Thus the step 506 further comprises a step of releasing the virtual group in response to the computed intersection quotient between the first group and the at least one second group satisfying a second threshold. For example, in the first example, Ann can initiate a request for releasing the virtual group for Ann, Alice and Bob. Moreover, Ann's instant messaging client or server also can initiate a request for releasing the virtual group by computing the intersection quotient between the two groups. Once Ann's instant messaging client receive the releasing request, it will release the virtual group.

With the method of the present disclosure, the instant messaging client can build a virtual group for a user so that the user can communicate multiple groups easy while other members in the multiple groups are not aware of the existence of virtual group so they will talk to the user freely.

According to one embodiment of the present disclosure, a computing system is disclosed. The computing system comprises a computer processor coupled to a computer-readable memory unit, the memory unit comprising instructions that when executed by the computer processor implements a method. In the method, a virtual group for a first group related to a first user and at least one second group related to the first user is built. And in response to receiving a message and receiver candidate of the message from the first user in the virtual group, wherein the receiver candidate is the first group and/or the at least one second group, the message is sent to the receiver candidate. Thus the first user is able to chat with the first group and/or the at least one second group in one chat window for the virtual group and members except for the first user among the virtual group are not aware of the existence of virtual group. In one embodiment, the virtual group is built in response to a request for building a virtual group for a first group related to a first user and at least one second group related to the first user. The request may be from s user, an instant messaging client or an instant messaging server. In another embodiment, the virtual group is built in response to a predefined condition being satisfied.

In one embodiment of the present disclosure, at least one third group related to the first user is added to the virtual group and optionally, the embodiment further comprises a step of sending the message to a receiver candidate in response to receiving a message and the receiver candidate of the message from the first user in the virtual group, wherein the receiver candidate is the first group and/or the at least one second group an or the at least third group. Thus, the first user is able to chat with the first group and/or the at least one second group and/or the at least one third group in one chat window for the virtual group and members except for the first user among the virtual group are not aware of the existence of virtual group. In one embodiment, the virtual group is built in response a request for adding at least one third group related to the first user to the virtual group.

In one embodiment of the present disclosure, the virtual group is released. The release may be either in response to a request for releasing the virtual group or in response to a predefined condition being satisfied. The request may be from s user, an instant messaging client or an instant messaging server.

In one embodiment of the present disclosure, a virtual group for a first group related to a first user and at least one second group related to the first user is built in response to an intersection quotient between the first group and the at least one second group satisfying a first threshold.

In one embodiment of the present disclosure, the virtual group is released in response to the computed intersection quotient between the first group and the at least one second group satisfying a second threshold.

In one embodiment of the present disclosure, the first group comprises the first user and a second user chatting with the first user, and the second group comprises the first user and a third user chatting with the first user, the intersection quotient is related to at least one of below: correlation between current topics talked within the first group and within the second group; or correlation between chat active time of the first group and the second group.

In one embodiment of the present disclosure, the first group comprises the first user and a second user chatting with the first user, and the second group comprises a first chat group including the first user, the intersection quotient is related to at least one of below: correlation between current topics talked within the first group and within the second group; or correlation between chat active time of the first group and the second group.

In one embodiment of the present disclosure, the first group comprises a first chat group including the first user, and the second group comprises a second chat group including the first user, the intersection quotient is related to at least one of below: number of common members in the first group and in the second group; correlation between current topics talked within the first group and within the second group; correlation between history topics talked within the first group and within the second group; or correlation between chat active time of the first group and the second group.

According to one embodiment of the present disclosure, a computer program product is disclosed. The computer program product is tangibly stored on a non-transient machine-readable medium and comprising machine-executable instructions. The instructions, when executed on an electronic device, cause the electronic device to: build a virtual group for a first group related to a first user and at least one second group related to the first user, and in response to receiving a message and a receiver candidate of the message from the first user in the virtual group, wherein the receiver candidate are the first group and/or the at least one second group, send the message to the receiver candidate. Thus the first user is able to chat with the first group and/or the at least one second group in one chat window for the virtual group and members except for the first user among the virtual group are not aware of the existence of virtual group. In one embodiment, the virtual group is built in response to a request for building a virtual group for a first group related to a first user and at least one second group related to the first user. The request may be from s user, an instant messaging client or an instant messaging server. In another embodiment, the virtual group is built in response to a predefined condition being satisfied.

In one embodiment of the present disclosure, the instructions may further cause the electronic device to: add at least one third group related to the first user to the virtual group, and optionally, the embodiment further comprises a step of sending the message to a receiver candidate in response to receiving a message and the receiver candidate of the message from the first user in the virtual group, wherein the receiver candidate are the first group and/or the at least one second group an or the at least third group. Thus, the first user is able to chat with the first group and/or the at least one second group and/or the at least one third group in one chat window for the virtual group and members except for the first user among the virtual group are not aware of the existence of virtual group. In one embodiment of the present disclosure, the instructions may further cause the electronic device to: release the virtual group. The release may be either in response to a request for releasing the virtual group or in response to a predefined condition being satisfied. The request may be from s user, an instant messaging client or an instant messaging server.

In one embodiment of the present disclosure, the instructions may further cause the electronic device to: build a virtual group for a first group related to a first user and at least one second group related to the first user in response to an intersection quotient between the first group and the at least one second group satisfying a first threshold.

In one embodiment of the present disclosure, the instructions may further cause the electronic device to: release the virtual group in response to the computed intersection quotient between the first group and the at least one second group satisfying a second threshold.

In one embodiment of the present disclosure, the instructions may further cause the electronic device to: build a virtual group for a first group related to a first user and at least one second group related to the first user in response to the request for building a virtual group.

In one embodiment of the present disclosure, the first group comprises the first user and a second user chatting with the first user, and the second group comprises the first user and a third user chatting with the first user, the intersection quotient is related to at least one of below: correlation between current topics talked within the first group and within the second group; or correlation between chat active time of the first group and the second group.

In one embodiment of the present disclosure, the first group comprises the first user and a second user chatting with the first user, and the second group comprises a chat group including the first user, the intersection quotient is related to at least one of below: correlation between current topics talked within the first group and within the second group; or correlation between chat active time of the first group and the second group.

In one embodiment of the present disclosure, the first group comprises a first chat group including the first user, and the second group comprises a second chat group including the first user, the intersection quotient is related to at least one of below: number of common members in the first group and in the second group; correlation between current topics talked within the first group and within the second group; correlation between history topics talked within the first group and within the second group; or correlation between chat active time of the first group and the second group.

The embodiments of the present disclosure may be implemented in various types of computing devices, for example, the embodiment may be implemented on a desktop, a laptop, a notebook, a server, a tablet, a smart phone and the like. Further, the embodiment of the present disclosure may be implemented on various operation systems such as Windows®, Linux®, Mac OS®, Android® and other operation systems, as long as these operation systems may support the method of the present disclosure to read/write the required data from/to the applications installed on the operation systems.

Various embodiments implementing the method of the present disclosure have been described above with reference to the accompanying drawings. Those skilled in the art may understand that the method may be implemented in software, hardware or a combination of software and hardware. Moreover, those skilled in the art may understand by implementing steps in the above method in software, hardware or a combination of software and hardware, there may be provided an apparatus/system based on the same disclosure concept. Even if the apparatus/system has the same hardware structure as a general-purpose processing device, the functionality of software contained therein makes the apparatus/system manifest distinguishing properties from the general-purpose processing device, thereby forming an apparatus/system of the various embodiments of the present disclosure. The apparatus/system described in the present disclosure comprises several means or modules, the means or modules configured to execute corresponding steps. Upon reading this specification, those skilled in the art may understand how to write a program for implementing actions performed by these means or modules. Since the apparatus/system is based on the same disclosure concept as the method, the same or corresponding implementation details are also applicable to means or modules corresponding to the method. As detailed and complete description has been presented above, the apparatus/system is not detailed below.

Moreover, the system may be implemented by various manners, including software, hardware, firmware or a random combination thereof. For example, in some embodiments, the apparatus may be implemented by software and/or firmware. Alternatively, or additionally, the system may be implemented partially or completely based on hardware. for example, one or more units in the system may be implemented as an integrated circuit (IC) chip, an application-specific integrated circuit (ASIC), a system on chip (SOC), a field programmable gate array (FPGA), etc. The scope of the present intention is not limited to this aspect.

The present disclosure may be a system, an apparatus, a device, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1-8. (canceled)

9. A computing system comprising a computer processor coupled to a computer-readable memory unit, the memory unit comprising instructions that when executed by the computer processor implements a method comprising:
in response to receiving a message and a receiver candidate of the message from the first user in the virtual group, wherein the receiver candidate are the first group and/or the at least one second group, sending the message to the receiver candidate;
wherein the first user is able to chat with the first group and the at least one second group in a single chat window for the virtual group; and
wherein only the first user is aware of the virtual group.

10. The system of claim 9, the method further comprising:
adding at least one third group related to the first user to the virtual group;
in response to receiving the message and the receiver candidate of the message from the first user in the virtual group, wherein the receiver candidate are the first group and/or the at least one second group an or the at least third group, sending the message to the receiver candidate; and
wherein the first user is able to chat with the first group and the at least one second group and the at least one third group in one chat window for the virtual group.

11. The system of claim 10, the method further comprising:
building a virtual group for the first group and the at least one second group in response to an intersection quotient between the first group and the at least one second group satisfying a first threshold.

12. The system of claim 11, wherein the first group comprises the first user and a second user chatting with the first user, and the second group comprises the first user and a third user chatting with the first user, the intersection quotient is related to at least one of below:
correlation between current topics talked within the first group and within the second group;
correlation between chat active time of the first group and the second group.

13. The system of claim 11, wherein the first group comprises the first user and a second user chatting with the first user, and the second group comprises a chat group including the first user, the intersection quotient is related to at least one of below:
correlation between current topics talked within the first group and within the second group;
correlation between chat active time of the first group and the second group.

14. The system of claim 11, wherein the first group comprises a first chat group including the first user, and the second group comprises a second chat group including the first user, the intersection quotient is related to at least one of below:
number of common members in the first group and in the second group;
correlation between current topics talked within the first group and within the second group;
correlation between history topics talked within the first group and within the second group;
correlation between chat active time of the first group and the second group.

15. A computer program product being tangibly stored on a non-transient machine-readable medium and comprising machine-executable instructions, the instructions, when executed on an electronic device, causing the electronic device to:
build a virtual group for a first group related to a first user and at least one second group related to the first user;
in response to receiving a message and a receiver candidate of the message from the first user in the virtual group, wherein the receiver candidate are the first group and/or the at least one second group, sending the message to the receiver candidate;
wherein the first user is able to chat with the first group and the at least one second group in a single chat window for the virtual group; and
wherein only the first user is aware of the virtual group.

16. The computer program product of claim 15, the instructions further causing the electronic device to:
add at least one third group related to the first user to the virtual group;
in response to receiving the message and the receiver candidate of the message from the first user in the virtual group, wherein the receiver candidate are the first group and/or the at least one second group an or the at least third group, sending the message to the receiver candidate; and
wherein the first user is able to chat with the first group and the at least one second group and the at least one third group in one chat window for the virtual group.

17. The computer program product of claim 15, the instructions further causing the electronic device to:
build a virtual group for a first group related to a first user and at least one second group related to the first user in response to an intersection quotient between the first group and the at least one second group satisfying a first threshold.

18. The computer program product of claim 17, wherein the first group comprises the first user and a second user chatting with the first user, and the second group comprises the first user and a third user chatting with the first user, the intersection quotient is related to at least one of below:
correlation between current topics talked within the first group and within the second group;
correlation between chat active time of the first group and the second group.

19. The computer program product of claim 17, wherein the first group comprises the first user and a second user chatting with the first user, and the second group comprises a chat group including the first user, the intersection quotient is related to at least one of below:
correlation between current topics talked within the first group and within the second group;
correlation between chat active time of the first group and the second group.

20. The computer program product of claim 17, wherein the first group comprises a first chat group including the first user, and the second group comprises a second chat group including the first user, the intersection quotient is related to at least one of below:
number of common members in the first group and in the second group;
correlation between current topics talked within the first group and within the second group;
correlation between history topics talked within the first group and within the second group;
correlation between chat active time of the first group and the second group.
